(19) United States
(12) Patent Application Publication
(10) Pub. No.: US 2007/0243417 A1
(43) Pub. Date: Oct. 18, 2007

(54) Magnetic Recording Medium, and Manufacturing Method and Manufacturing Apparatus of the Same, Recording and Reproduction Method of Magnetic Recording Medium, and Recording and Reproduction Apparatus of the Same

(76) Inventors: Motoyoshi Murakami, Osaka (JP); Masahiro Birukawa, Osaka (JP)

Correspondence Address: WENDEROTH, LIND & PONACK L.L.P., 2033 K. STREET, NW, SUITE 800, WASHINGTON, DC, 20006, US

(21) Appl. No.: 10/588,304

(22) PCT Filed: Feb. 25, 2005
(86) PCT No.: PCT/JP05/03208

§ 371 Date: Aug. 3, 2006

(30) Foreign Application Priority Data
Feb. 27, 2004 (JP) 2004-054090

(51) Int. Cl. G11B 5/66

(52) U.S. Cl. 428/818; 369/13.56; 427/131

(57) ABSTRACT

The object of the present invention is to provide a medium that recording and reproducing is performed by irradiation with light from a film surface and has high reliability and excellent heat endurance. To achieve the object, over a recording film having at least a magnetically anisotropy, which is formed on a disk substrate, a lubricating layer is formed with a protective layer having a lower thermal conductivity than the recording film being interposed therebetween.

### TECHNICAL FIELD

The present invention relates to a rewritable magnetic recording medium, or particularly to a magnetic recording medium with which signals are recorded and reproduced while the recording medium is irradiated with light to raise its temperature, and to a manufacturing method, manufacturing apparatus, recording and reproduction method, and recording and reproduction apparatus of the same.

### BACKGROUND ART

Magnetic recording media using light, and optical recording media such as phase-change recording media, are portable recording media that allow large capacities of information to be recorded at high density, and as the trend toward multimedia has continued in recent years, there has been a surge in demand for media with which large-capacity computer files or moving pictures can be recorded.

An optical recording medium generally has a structure in which a multilayer thin film such as a recording film that includes a recording layer is formed on a transparent, disk-shaped substrate made of plastic or the like. This optical recording medium is irradiated with a laser to record and erase information, and the reflected laser light is used to reproduce information.

Conventional magnetic recording media using light have mainly been what is known as optical modulation recording systems, in which information that has been recorded by adding a stationary magnetic field is erased, after which new information is recorded by adding a stationary magnetic field in the opposite direction. More recently, however, attention has shifted to magnetic field modulation systems because they make possible recording in a single rotation (direct overwrite) and allow accurate recording even at high density levels. Also, phase-change optical recording media have been gaining popularity because they afford direct overwrite by employing optical modulation recording and allow reproduction with the same optical system as a CD or DVD.

The recording density limit of an optical recording medium is determined by the laser wavelength (λ) of the light source, and is a function of the diffraction limit (≈λ/(2NA); where NA is the numerical aperture of the objective lens). In recent years a system has been proposed in which a NA of 0.8 or higher is attained by using a set of two objective lenses, and these systems have undergone considerable development. The laser used for recording and reproduction is directed through the substrate at a recording film that includes a recording layer, but as the NA increases, aberration caused by tilt of the substrate and so forth increases when light passes through the substrate, so the substrate has to be made thinner. In this case, a substrate such as with thickness of 0.5 mm or less is hard enough to be kept in a correct position during manufacturing the medium, so a method for recording and reproducing through a protection coating over a thin film is proposed when using a system including the objective lens of high NA (see Non-Patent Document 1).

Furthermore, for example, a technique to improve reproduction resolution by irradiating light beam from a film surface, increasing NA of the objective lens and using near-field light (see Patent Document 1). The technique enables to improve detection resolution more than the method that the light beam enters through the substrate. Also, since aberration of light beam caused by tilt of the substrate and so forth is not affected, good reproducing signals can be obtained even at high density recording.

Patent Document 1: Japanese Unexamined Patent Publication, No. H11-345442

Non-Patent Document 1: Jpn.J. Appl.Phys.36, pp. 456-459 (1997)

### DISCLOSURE OF THE INVENTION

Even when the above-mentioned conventional optical head of high NA is used, however, detection resolution has its limit depends on light wavelength and NA. Also, in a recording and reproducing method using a magnetic head such as a GMR head and applying light, if the temperature of the recording medium rises, then the temperature of the lubricating layer for sliding the magnetic head also rises, and the sliding characteristics change and reliabilities deteriorate.

The object of the present invention is to provide a magnetic recording medium that recording and reproducing is performed with temperature rise of a recording film by applying a light and has excellent signal characteristics and heat endurance by improving characteristics of a lubricating layer.

A magnetic recording medium of the present invention has at least a magnetically anisotropic recording film on a disk substrate, and comprises a lubricating layer over at least the recording film, with a protective layer having a lower thermal conductivity than the recording film being interposed therebetween.

As a result, a magnetic recording medium with excellent signal characteristics can be obtained that is possible to block a thermal effect over the lubricating layer due to temperature rise of the recording layer, and to prevent temperature rise of a magnetic head for recording and reproducing.

The protective layer has a thermal conductivity of 1×10⁶ erg/(s·K·cm) or less.

Also, the protective layer may comprise a plurality of thin films. The plurality of thin films each preferably has a different thermal conductivity. Further, the thermal conductivity of the thin film on the recording film side is higher than the thermal conductivity of the thin film on the lubricating layer side.

The protective layer comprising a plurality of thin films preferably has at least a thin film whose thermal conductivity is 1×10⁶ erg/(s·K·cm) or less.

As a result, a magnetic recording medium with excellent signal characteristics can be obtained.

The protective layer preferably has carbon as a main component. Also, the protective layer preferably includes diamond-like carbon, and furthermore, includes nitrogen, oxygen, or hydrogen. In a plurality of thin films of the protective layer, the nitrogen, oxygen, or hydrogen content is preferably varied within the plurality of thin films of the protective layer.

The protective layer preferably includes a material having heat resistance at a temperature of at least 250° C. Also the heat resistant protective layer is preferably composed of a fluororesin or a ceramic material, and furthermore, composed of Teflon®.

The protective layer may include a metal material. Also, the metal material may be composed of titanium, tantalum, and chromium, and furthermore, may be composed of a nitrogen compound or an oxide.

In addition, the protective layer may include at least a chalcogen compound.

As a result, a magnetic recording medium with protection and heat blocking effects of the recording film and the lubricating layer can be obtained.

The lubricating layer preferably comprises a plurality of thin films, and the plurality of thin films each preferably have a different thermal conductivity.

The lubricating layer may include PFPE, a heat resistant material, or an oxide or a nitride.

As a result, a magnetic recording medium with excellent signal characteristics and heat endurance can be obtained.

The combined thickness of the lubricating layer and the protective layer is preferably at least 1 nm and no more than 100 nm. Also, the thickness of the lubricating layer is preferably at least 0.5 nm and no more than 20 nm. Or the thickness of the protective layer is preferably at least 0.5 nm and no more than 99.5 nm.

The recording film includes a magnetic layer having magnetic anisotropy in the direction perpendicular to the film plane. Also, the recording film preferably comprises a plurality of magnetic layers, and the recording film comprises at least a recording layer, an intermediate layer, and a reproduction layer, which are laminated over one another.

As a result, reproducing signal transferred to the reproduction layer can be increased.

In the magnetic recording medium of the present invention, the recording domain formed on the recording layer in the recording film is transferred to the reproduction layer, and recorded information is reproduced by domain wall displacement in the reproduction layer.

The recording layer preferably includes at least terbium, iron, and cobalt.

The recording layer is preferably laminated intermittently and periodically for each layer of different material or compositional ratio.

A pit-shaped pattern is preferably formed on the disk substrate according to the pattern of the recording domain formed in the recording layer. Also, a pit-shaped pattern that is smaller than the smallest pattern of the recording domain formed in the recording layer is preferably formed on the disk substrate.

As a result, stable information recording and reproducing is possible.

In the magnetic recording medium, at least a metal layer with a high thermal conductivity is preferably provided between the disk substrate and the recording film.

In addition, a dielectric layer is preferably provided between the recording film and the metal layer. Also, a dielectric layer is preferably provided between the disk substrate and the metal layer. The metal layer or the dielectric layer has an etched surface. In such a case, at least the metal layer or the dielectric layer preferably has a surface roughness Ra of at least 0.5.

Here, the dielectric layer preferably includes at least a chalcogen compound.

As a result, a magnetic recording medium with excellent signal characteristics can be obtained even when information is recorded and reproduced with high density.

A method for manufacturing a magnetic recording medium of the present invention comprising, forming at least a magnetically anisotropic recording film on a disk substrate, forming a protective layer having a lower thermal conductivity than the recording film over the recording film, and forming a lubricating layer over the protective layer. The lubricating layer is preferably formed in a vacuum. Also, the lubricating layer is preferably formed by coating after the protective layer has been formed.

As a result, a magnetic recording medium with excellent signal characteristics and no deterioration of recording and reproducing characteristics can be obtained even when information is recorded and reproduced with high density.

An apparatus for manufacturing a magnetic recording medium of the present invention comprising, a recording film formation unit for forming at least a magnetically anisotropic recording film on a disk substrate, a protective layer formation unit for forming a protective layer having a lower thermal conductivity than the recording film over the recording film, and a lubricating layer formation unit for forming a lubricating layer over the protective layer.

As a result, a magnetic recording medium with excellent signal characteristics and no deterioration of recording and reproducing characteristics can be obtained even when information is recorded and reproduced with high density.

In a method for recording to or reproducing from a magnetic recording medium of the present invention, information is recorded to or reproduced from the magnetic recording medium by applying a laser beam to the information recording medium to raise the temperature of the recording film of the recording medium.

As a result, recording and reproducing with excellent signal characteristics is possible. An apparatus for recording to or reproducing from a magnetic recording medium of the present invention comprising a heating unit for raising the temperature of the magnetic recording medium, and a recording and reproduction unit for magnetically recording and reproducing signals to and from the magnetic recording medium when the heating unit raises the temperature of the magnetic recording medium, and the temperature distribution in the signal region of the magnetic recording medium during signal recording to the magnetic recording medium is different from that during signal reproduction.

As a result, recording and reproducing with excellent signal characteristics is possible.

As mentioned above, in a magnetic recording medium that recording and reproducing is performed with temperature rise of a recording film by applying a light, endurance and reliability of the recording medium and magnetic head can be improved. Also, it is possible to provide a magnetic recording medium having no deterioration of recording and reproducing characteristics caused by the temperature rise of the magnetic head, and having excellent signal characteristics

### BRIEF DESCRIPTION OF THE DRAWINGS

FIG. 1 is a cross-sectional view of the structure of the magnetic recording medium in Embodiment 1 of the present invention;

FIG. 2 is a cross-sectional view of the structure of the magnetic recording medium in Embodiment 2 of the present invention;

FIG. 3 is a cross-sectional view of the structure of the magnetic recording medium in Embodiment 3 of the present invention;

FIG. 4 is a cross-sectional view of the structure of the magnetic recording medium in Embodiment 4 of the present invention;

FIG. 5 is a cross-sectional view of the structure of the magnetic recording medium in Embodiment 5 of the present invention;

FIG. 6 is a cross-sectional view of the structure of the magnetic recording medium in Embodiment 6 of the present invention;

FIG. 7 illustrates the operation of reproducing information from a cross-sectional view of a magnetic recording medium in an embodiment of the present invention, in which: (a) is a cross-sectional view of the structure of the recording film of the magnetic recording medium (and particularly the direction of magnetization), (b) is a graph of the temperature distribution inside the medium versus the position of the magnetic recording medium during the reproduction operation, (c) is a graph of the magnetic wall energy density of the reproduction layer, and (d) is a graph of the force that attempts to move the magnetic wall of the reproduction layer;

FIG. 8 is a graph of magnetic characteristics against the temperature of the magnetic recording medium of Embodiment of the present invention;

FIG. 9 is a diagram of the structure of the recording and reproduction apparatus in Embodiment 7 of the present invention; and

FIG. 10 is a diagram of the structure of the film formation apparatus in Embodiment 8 of the present invention.

### NUMERICAL REFERENCE

10, 20, 30, 40, 50, 60 magnetic recording medium
11, 21, 31, 41, 51, 61 disk substrate
32, 52, 62 heat-radiating layer
53 heat-resistant layer
22, 42 dielectric layer
63 under heat-blocking layer
12, 23, 33, 43, 54, 64 recording film
13, 24, 34, 44, 55, 65 protective layer
14 lubricating layer
25, 35, 45, 56, 66 first lubricating layer
26, 36, 46, 57, 67 second lubricating layer
15, 68 etching surface
70 vacuum transport chamber
71 vacuum degassing chamber
72 loading and unloading chamber
73 vacuum main chamber
74 loading chamber
75 unloading chamber
77 heating chamber
81-87 vacuum processing chamber
101 recording layer
102 intermediate layer
103 reproducing layer
112 magnetic head
113 spindle motor
114 optical head
115 laser drive circuit
116 control and detection circuit
117 motor drive and control circuit
118, 119, 120, 121 optical element

### DESCRIPTION OF THE PREFERRED EMBODIMENT

The present invention will now be described in detail, but to the extent that the gist thereof is not exceeded, the present invention is not limited to the following embodiments.

The magnetic recording medium of the present invention has a lubricating layer formed over a recording film, with a heat-blocking protective layer whose thermal conductivity is lower than that of the recording film interposed therebetween, which prevents the temperature from rising on the second lubricating layer side when the recording film is irradiated with a laser beam during recording and reproduction. As a result, it is possible to obtain a magnetic recording medium that will have excellent heat resistance and excellent signal characteristics, even when the temperature of the recording film is raised by a light beam or the like, and a signal is reproduced using a magnetic head such as a GMR head. The structure of a magnetic recording medium that solves the following problems will be described in the first to sixth embodiments.

### First to Third Embodiments

With a conventional magnetic recording medium, when the recording film is irradiated with a laser beam, the temperature of the lubricating layer also rises and sliding characteristics deteriorate, or thermal conduction to the magnetic head diminishes the recording and reproduction characteristics, among other such problems. Also, if the laser beam intensity is lowered so as to suppress this rise in temperature, the drawback is that a larger recording magnetic field is required, or there is a decrease in the reproduction signal capacity.

### Fourth to Sixth Embodiments

In the past, to facilitate domain wall displacement in a reproduction layer transferred from a recording layer with a magnetic recording medium that made use of a DWDD system, the recording film was irradiated with a laser beam spot, and the temperature gradient in the recording film had to be utilized to stably displace the wall of the magnetic domain transferred to the reproduction layer, and to detect the signal. However, a problem was that the reproduction signal transferred to the reproduction layer fluctuated due to changes in the characteristics of the magnetic head and fluctuations in the float characteristics caused by the raising of the lubricating layer temperature.

Also, in the seventh embodiment are discussed the recording and reproduction method and the recording and reproduction apparatus of the present invention, in the eighth embodiment is discussed an example of producing the layers that make up the magnetic recording medium of the present invention, and in the other embodiments are discussed further modifications and so forth based on embodiments.

### First Embodiment

This embodiment will now be described in detail through reference to the drawings.

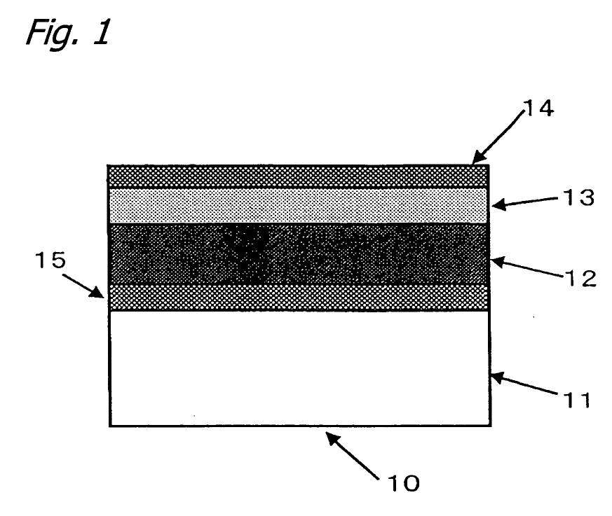

FIG. 1 is a cross-sectional view of the structure of a magnetic recording medium (hereinafter referred to as magnetic disk) 10 in the first embodiment of the present invention. 11 is a transparent disk substrate made of glass, 12 is a recording film, 13 is a dielectric protective layer for protecting the recording film and shielding the recording film 12 and lubricating layer 14 from heat, and 14 is a lubricating layer for sliding a magnetic head. The side of the substrate on which the recording film 12 is formed is prepared by adjusting the surface roughness by ion etching. The medium is irradiated with a laser beam from the lubricating layer 14 side. The recording and reproduction of signals are performed with a magnetic head, and the recording and reproduction of recording marks smaller than the diffraction limit of the irradiating laser beam spot are possible.

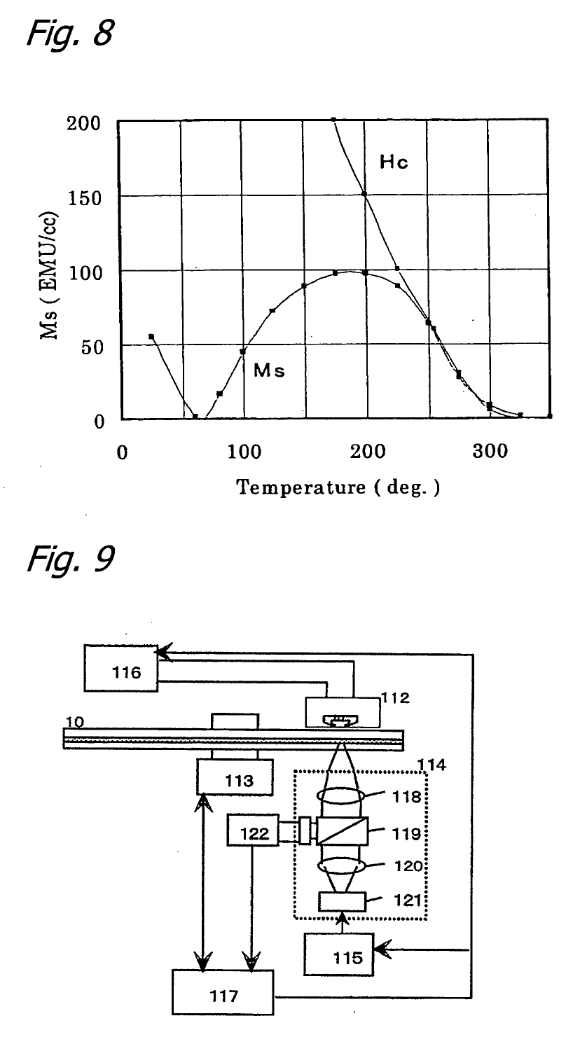

FIG. 8 shows the relation between the temperature T of the recording film of this embodiment and the coercive force Hc and the saturation magnetization Ms. With the magnetic recording medium of this embodiment, information is recorded by the magnetic head while the disk rotates and is irradiated with the laser beam spot along a track. Here, as shown in FIG. 8, recording with the magnetic layer is possible because the coercive force of the recording film decreases at higher temperatures. During signal reproduction, the medium is irradiated with the laser beam to raise its temperature, while the recording magnetic domain is detected by a GMR head. Here, the saturation magnetization Ms is at its minimum at 80° C. and then rises along with temperature, reaching its maximum at 180° C., so detection sensitivity with the GMR head is improved and the reproduction signal is increased.

Therefore, the recording film irradiated with the laser beam here has a temperature distribution throughout the film, and the temperature is over 200° C. in the center portion of the laser beam spot. Accordingly, the protective layer must have heat resistance up to at least 250° C. in order to maintain the sliding characteristics of the surface lubricating layer. In this embodiment, a fluororesin, or a ceramic material, or preferably a Teflon thin film is used for the heat-resistant protective layer, which results in a magnetic recording medium that has heat resistance of 280° C. or higher, and in which the recording film and lubricating layer are protected and shielded from heat.

Next, the constitution of the magnetic disk 10, and how it is manufactured, will be described in detail.

As shown in FIG. 1, the recording film and so forth (magnetic thin films) are laminated over the disk substrate 11. The disk substrate 11 has lands formed on both sides of a groove, and the depth h of the rectangular groove is 35 nm from the top face of the lands 3. The track pitch of the magnetic disk 10 in this embodiment is 0.4 μm, and the groove width is 0.3 μm.

First, an etching surface 15 is formed with an ion gun on the surface of the disk substrate 11, which is composed of transparent glass in which lands and grooves have been formed.

Next, a target is installed in a DC magnetron sputtering apparatus, and the disk substrate is fixed in a substrate holder, after which the inside of the chamber is vacuum evacuated with a turbo molecular pump to a high vacuum of 8×10⁻⁶ Pa or less. With this vacuum evacuation in progress, argon gas is introduced into the chamber up to 1.5 Pa, and the substrate is rotated while a TbFeCo recording film 12 is formed in a thickness of 40 nm, using terbium, iron, and cobalt targets, by DC magnetron sputtering. The composition of the TbFeCo film here can be matched to the desired film composition by adjusting the target power ratio.

Then, argon gas and N₂ gas are introduced into the chamber until 0.3 Pa is reached, and the substrate is rotated while a dielectric protective layer 13 composed of SiN is formed in a thickness of 5 nm by reactive sputtering.

A lubricating layer composed of amorphous carbon is formed in a thickness of 5 nm over the protective layer 13 by reactive RF sputtering, using a carbon target in a mixed atmosphere of argon and CH₄. This product is coated with perfluoropolyether (hereinafter referred to as PFPE) to form a solid lubricating layer 14. The composition of the recording film 12 composed of TbFeCo here was adjusted by setting the power levels of the various targets so that the temperature of compensation composition would be −50° C. and the Curie temperature 310° C.

As a result, the film characteristics thus obtained are such that the saturation magnetization Ms rises along with temperature, reaching its maximum at 180° C., and the coercive force Hc decreases as the temperature is raised from room temperature. Thus, with the magnetic recording medium of this embodiment, a stable recording magnetic domain can be formed even when a tiny domain is recorded, and the saturation magnetization Ms is at its maximum at the temperature (180° C.) at which laser beam irradiation is performed, and recording and reproduction with excellent signal characteristics are possible even when repeated recording and reproduction are performed with a magnetic head.

The magnetic disk 10 in this embodiment was described as having a structure in which a recording film was formed on a disk substrate in which rectangular lands and grooves had been formed in a photopolymer, but a glass substrate may instead be directly worked, or imprinting or another such method may be employed.

Also, the same characteristics were obtained whether the information was recorded to the lands or to the grooves, or to the lands and grooves. Furthermore, with this embodiment the track pitch was 0.4 μm, and the effect will be better if the width of the grooves in which the information is recorded is 0.5 μm or less, and if information is recorded to a recording domain in which the length of the shortest mark of the recorded information is 0.3 μm or less.

As discussed above, the constitution of this embodiment allows stable recording and reproduction characteristics to be obtained even in high-density recording and reproduction.

### Second Embodiment

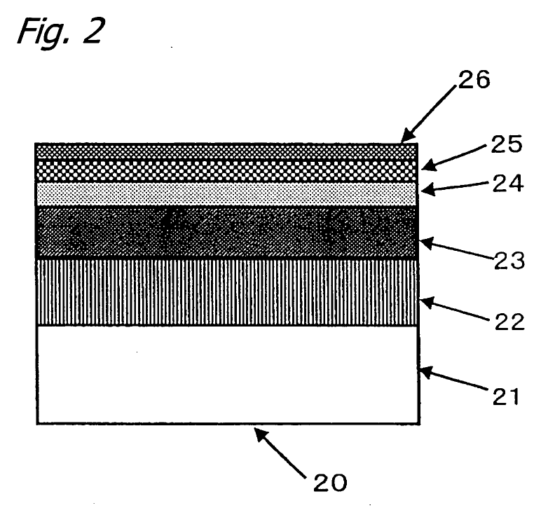

FIG. 2 is a cross-sectional view of the structure of a magnetic disk 20 in a second embodiment of the present invention.

21 is a disk substrate made of transparent glass, 22 is a dielectric layer composed of a dielectric material with a low thermal conductivity, and serves as a under heat-blocking layer for protecting the recording film and adjusting the under surface. 23 is a recording film, composed of a recording layer in which recording information is stored, and a reproduction layer for increasing the signal of reproduction information. The reproduction layer and the recording layer are magnetically exchange coupled. 24 is a heat-blocking protective layer, which is formed over the recording film 23 for shielding the recording film 23 and the lubricating layer from heat. A first lubricating layer 25 and a second lubricating layer 26 are further formed to improve the float characteristics of the magnetic head. A laser beam irradiates from the second lubricating layer 26 side. The recording and reproduction of signals are performed with a magnetic head, and the recording and reproduction of recording marks smaller than the diffraction limit of the irradiating laser beam spot are possible.

In particular, with the magnetic disk 20 of this embodiment, information is recorded by the magnetic head while the disk rotates and is irradiated with the laser beam spot along a track. Here, just as in the first embodiment, recording with the magnetic layer is possible because the coercive force of the recording film decreases at higher temperatures. During signal reproduction, the medium is irradiated with the laser beam to raise its temperature, while the recording magnetic domain is detected by a GMR head. Here, the saturation magnetization Ms of the reproduction layer rises along with temperature, reaching its maximum at 120° C., so the signal capacity detected by the GMR head is increased, and the reproduction signal amplitude is also increased.

Next, the constitution of the magnetic disk 20, and how it is manufactured, will be described in detail.

As shown in FIG. 2, the recording film 23, which comprises multiple laminated layers including the above-mentioned magnetic films, is formed on the disk substrate 21. The disk substrate 21 has a format in which rewritable regions are provided in a track alternately with pit regions in which servo-use wobble pits and address pits have been formed. An address is detected while a tracking servo is actuated, and information can be recorded to and reproduced from the rewritable regions. The constitution here is such that there are prepits having a depth of from 20 to 180 nm, signals from the prepits of address pits or the like can be detected, and recording and reproduction can be accomplished.

First, a boron-doped silicon target is installed in a DC magnetron sputtering apparatus, and the disk substrate is fixed in a substrate holder, after which the inside of the chamber is vacuum evacuated with a turbo molecular pump to a high vacuum of 8×10⁻⁶ Pa or less. With this vacuum evacuation in progress, argon gas and N₂ gas are introduced into the chamber up to 3.0 Pa, and the substrate is rotated while an SiN film (as a dielectric layer 22) is formed by reactive sputtering in a thickness of 50 nm over the disk substrate 21 composed of transparent glass and in which prepits have been formed.

With the vacuum evacuation still in progress, argon gas is introduced into the chamber up to a pressure of 0.5 Pa, and the substrate is rotated while a recording layer is formed by DC magnetron sputtering in a thickness of 60 nm over the dielectric layer 22, with argon gas introduced into the chamber up to 1.5 Pa and using a terbium target and an FeCo target such that terbium and FeCo are periodically laminated. The TbFeCo film composition here can be matched to the desired film composition by adjusting the target power ratio. Next, gadolinium, iron, cobalt, and aluminum targets are used to form a reproduction layer composed of GdFeCoAl in a thickness of 30 nm by DC magnetron sputtering. The recording film 23 composed of a recording layer and a reproduction layer can be formed by the above method.

Then, argon gas is introduced into the chamber up to 0.5 Pa and the substrate is rotated while a protective layer 24 composed of a Teflon thin film is formed by reactive sputtering in a thickness of 10 nm, using a Teflon target.

A first lubricating layer (solid lubricating layer) 25 composed of diamond-like carbon (DLC) is formed in a thickness of 10 nm over the protective layer 24 by plasma CVD in a mixed atmosphere of argon and CH₄. A second lubricating layer 26 composed of perfluoropolyether is then formed by dip coating.

The composition of the recording film 23 composed of TbFeCo here was adjusted by setting the power levels of the various targets so that the temperature of compensation composition would be 50° C. and the Curie temperature 320° C. The GdFeCoAl reproduction layer has the temperature of compensation composition of −20° C. and a Curie temperature of 270° C., and as a result, the saturation magnetization Ms of the reproduction layer rises along with temperature, reaching its maximum at 110° C. The film characteristics thus obtained are such that the coercive force Hc rises from room temperature up to the temperature of compensation composition, but decreases when the temperature is further raised. Accordingly, with the magnetic disk 20 of this embodiment, a stable recording magnetic domain can be formed even when a tiny domain is recorded, the saturation magnetization Ms reaches its maximum at the temperature (110° C.) at which laser beam irradiation is performed, and recording and reproduction with excellent signal characteristics are possible even when repeated recording and reproduction are performed with a magnetic head.

The method for manufacturing the recording layer will now be described in further detail. The recording layer in this embodiment is formed by DC magnetron sputtering in a thickness of 60 nm, with argon gas introduced into the chamber up to 1.5 Pa and using a terbium target and an FeCo target such that terbium and FeCo are periodically laminated. During the production of the TbFeCo film of the recording layer, an amorphous magnetic thin film having a structure in which terbium and the transition metals iron and cobalt are periodically laminated at 1.5 nm can be formed by controlling the rotational speed of the disk substrate and the film production rate. More specifically, the above-mentioned film structure is obtained by having the particles of each of the elements formed at a rate of 0.7 nm/sec while undergoing planetary rotation at 40 rpm. The composition of the TbFeCo film can be matched to the desired film composition by adjusting the target power ratio.

Thus employing a periodic laminated structure of 2.0 nm or less for at least the recording layer allows the product of the coercive force Hc and the saturation magnetization Ms of the recording layer to be increased, yielding an Ms·Hc value of at least 3.0×10⁶ erg/cm³. Actually, with the recording layer in this embodiment, a large Ms·Hc value of 4.2×10⁶ erg/cm³ is obtained. A stable recording magnetic domain can be formed even when a tiny domain of 70 nm or less is recorded, and recording and reproduction with excellent signal characteristics are possible even when repeated recording and reproduction are performed.

An examination of the dependence of Ms·Hc on the period of the laminated structure of the recording layer of the magnetic disk 20 reveals that the Ms·Hc value increases when the recording layer lamination period is 2 nm or less, and is substantially at its maximum with a 1.0 nm periodic structure. Therefore, for the Ms-Hc value to be at least 3.0×10⁶ erg/cm³, the lamination period must be no more than 2.0 nm.

An examination of the dependence of the recording mark length limit on the Ms·Hc value of the recording layer of the magnetic disk 20 reveals that the mark length that is the recording limit becomes shorter when the Ms·Hc value of the recording layer is larger, and the recording layer of the periodic laminated structure of this embodiment affords excellent stability of a tiny magnetic domain. If the Ms·Hc value is at least 3.0×10⁶ erg/cm³, then even with a recording magnetic domain having a mark length of 80 nm or less, stable recording and reproduction will still be possible, and even when using a recording film having a two-layer structure comprising a recording layer and a reproduction layer, the recorded information of the recording layer will be stably transferred to the reproduction layer, the signal amplitude will be expanded, and excellent recording and reproduction signals will be obtained.

As discussed above, the constitution of this embodiment yields stable recording and reproduction characteristics even when recording and reproduction are performed at high density with a magnetic head.

The recording layer of the magnetic disk 20 in this embodiment had a structure in which terbium and FeCo were periodically laminated at 1.5 nm, but is not limited to this structure, and a similar effect will be obtained with a structure in which the lamination period is at least 0.4 nm and no more than 2 nm, and with a structure in which the recording layer is formed in a thickness of at least 50 nm, and preferably from 60 to 200 nm.

Also, a structure in which terbium and the transition metals iron and cobalt are periodically laminated was discussed above in this embodiment, but the present invention is not limited to this structure, and the structure may instead be such that different targets of terbium, iron, and cobalt are used, or other materials are contained, or a structure in which the recording layer has a lamination period of 2 nm or less may be used.

As discussed above, with the present invention, tiny magnetic domains of 0.3 μm or less can be stably formed with a recording film in which a recording layer and a reproduction layer are laminated in a periodic lamination structure that allows recorded information to be rewritten, and a reproduction signal transferred to the reproduction layer can be made larger. Furthermore, since the recording magnetic domains in the information track are formed in a stable shape, there is also less cross-write and cross-talk from adjacent tracks during recording and reproduction.

### Third Embodiment

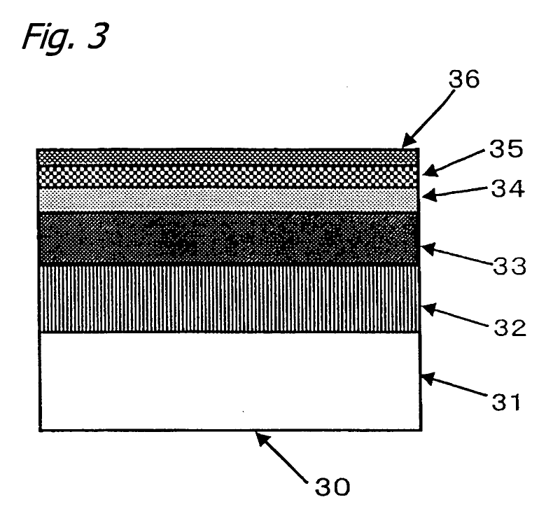

FIG. 3 is a cross-sectional view of the structure of a magnetic disk 30 in a third embodiment of the present invention. 31 is a disk substrate made of transparent glass, and 32 is a heat-radiating layer composed of a metal material with a high thermal conductivity, and which diffuses heat from the recording film and protects the recording film. 33 is a laminated recording film, formed by a recording layer in which recorded information is stored, a reproduction layer for increasing the recording and reproduction signal capacity, and an intermediate layer that controls the exchange coupling force between the reproduction layer and the recording layer. 34 is a heat-blocking protective layer, which is formed over the recording film 33 to shield the recording film 33 and the lubricating layer from heat. Further, a first lubricating layer 35 and a second lubricating layer 36 are formed to improve the float characteristics of the magnetic head.

The magnetic disk 30 shown in FIG. 3 has a structure that can be applied to a magnetic recording medium with which it is possible to record and reproduce recording marks that are smaller than the diffraction limit of the irradiating laser beam spot by having the laser beam irradiate from the lubricating layer side where the recording film is formed, and recording and reproducing the signals with the magnetic head.

In particular, with the magnetic recording medium of this embodiment, information is recorded by the magnetic head while the disk rotates and is irradiated with the laser beam spot along a track. Here, just as in the first embodiment, recording with the magnetic layer is possible because the coercive force of the recording film decreases at higher temperatures. During signal reproduction, the medium is irradiated with the laser beam to raise its temperature, while the recording magnetic domain is detected by a GMR head. Here, the saturation magnetization Ms of the reproduction layer rises along with temperature, reaching its maximum at 130° C., so the signal capacity detected by the GMR head is increased, and the reproduction signal amplitude is also increased.

Next, the constitution of the magnetic disk 30, and how it is manufactured, will be described in detail.

As shown in FIG. 3, the recording film 33, which comprises multiple laminated layers including the above-mentioned magnetic films, is formed on the disk substrate 31. The disk substrate 31 has a format in which rewritable regions are provided in a track alternately with pit regions in which servo-use wobble pits and address pits have been formed. An address is detected while a tracking servo is actuated, and information can be recorded to and reproduced from the rewritable regions. The constitution here is such that there are prepits having a depth of from 20 to 180 nm, signals from the prepits of address pits or the like can be detected, and recording and reproduction can be accomplished.

First, an AlTi target is installed in a DC magnetron sputtering apparatus, and the disk substrate is fixed in a substrate holder, after which the inside of the chamber is vacuum evacuated with a turbo molecular pump to a high vacuum of 8×10⁻⁶ Pa or less. With this vacuum evacuation in progress, argon gas is introduced into the chamber up to 0.5 Pa, and the substrate is rotated while a heat-radiating layer 32 composed of a metal material (AlTi) is formed in a thickness of 60 nm over the disk substrate 31 composed of transparent glass and in which prepits have been formed.

With the vacuum evacuation still in progress, argon gas is introduced into the chamber up to a pressure of 1.5 Pa, and the substrate is rotated while a recording layer is formed by DC magnetron sputtering in a thickness of 80 nm over the heat-radiating layer 32, using a TbFeCo alloy target. The TbFeCo film composition here can be matched to the desired film composition by adjusting the alloy target compositional ratio. Next, using a TbDyFeCoAl alloy target, an intermediate layer composed of TbDyFeCoAl is formed by DC magnetron sputtering in a thickness of 15 nm. Then, using a GdFeCoAl alloy target, a reproduction layer composed of GdFeCoAl is formed by DC magnetron sputtering in a thickness of 35 nm. This forms a recording film 33 with a three-layer structure comprising a recording layer, intermediate layer, and reproduction layer.

Then, argon gas and N₂ gas are introduced into the chamber until 0.3 Pa is reached, and the substrate is rotated while a protective layer 34 composed of SiN is formed in a thickness of 10 nm by reactive sputtering.

A first lubricating layer (solid lubricating layer) 35 composed of diamond-like carbon (DLC) is formed in a thickness of 12 nm over the protective layer 34 by plasma CVD in a mixed atmosphere of argon, CH₄, and H₂. A second lubricating layer 36 composed of perfluoropolyether is then formed in a thickness of 2 nm by dip coating.

The film composition here was adjusted by setting the compositional ratio of the target so that the temperature of compensation composition would be 90° C. and the Curie temperature 310° C. in the recording film 12 composed of TbFeCo. The TbDyFeCoAl intermediate layer is adjusted to a temperature of compensation composition of 20° C. and a Curie temperature of 180° C., and the GdFeCoAl reproduction layer to a temperature of compensation composition of −60° C. and a Curie temperature of 290° C. As a result, the film characteristics thus obtained are such that the coercive force Hc rises from room up to the temperature of compensation composition, but decreases when the temperature is further raised. Also, the saturation magnetization Ms of the reproduction layer rises along with the temperature, reaching its maximum at 130° C., and when the intermediate layer is at or over the Curie temperature, exchange coupling between the recording layer and the reproduction layer is interrupted, so even tiny recording marks will be transferred to the reproduction layer and detected as a large signal capacity.

As a result, with the magnetic disk 30 of this embodiment, the saturation magnetization Ms is high over a range of from 110° C. to 170° C., which is the temperature range under irradiation with the laser beam. Accordingly, because of magnetically induced super resolution, stable recording magnetic domains can be formed, without surrounding recording magnetic domains being transferred even in the recording of tiny magnetic domains, and recording and reproduction with excellent signal characteristics are possible even when repeated recording and reproduction are performed with a magnetic head.

With the method for manufacturing a recording layer in this embodiment, during the production of the TbFeCo film of the recording layer, the microstructure of the terbium, iron, and cobalt films can be varied by controlling the rotational speed of the disk substrate and the film production rate, and a magnetic thin film with an amorphous film structure with high magnetic anisotropy in the direction perpendicular to the film plane can be formed. More specifically, the above-mentioned film structure is obtained by having the particles of each of the elements formed at a rate of 0.5 nm/sec while undergoing planetary rotation at 40 rpm. The composition of the TbFeCo film can be matched to the desired film composition by adjusting the target composition and the film formation conditions.

As discussed above, when a recording film with a three-layer structure comprising a recording layer, intermediate layer, and reproduction layer is used, the recorded information of the recording layer can be stably detected by the magnetic head, and stable reproduction characteristics can be obtained even when recording and reproduction are performed at high density.

As a result, with the present invention, because the structure is such that a lubricating layer is formed via a heat-blocking layer over a recording film having a structure in which a recording layer capable of rewriting recorded information, an intermediate layer, and a reproduction layer are laminated in that order, tiny magnetic domains of 0.3 μm or less can be stably formed, and the reproduction signals transferred to the reproduction layer can be larger. Furthermore, since the recording magnetic domains in the information track are formed in a stable shape, there is also less cross-write and cross-talk from adjacent tracks during recording and reproduction.

The above effects are even more pronounced if the lubricating layer here is made up of a plurality of thin films. Specifically, with the magnetic disk 30 of this embodiment, during DLC film formation, a lubricating layer is formed with the amount of H₂ set to 3% versus the argon, after which a lubricating layer is formed with the amount of H₂ set at 0.5%, and then a PFRE lubricating layer is formed by coating. Thus employing a plurality of lubricating layers further enhances the heat blocking effect between the recording layer and the lubricating layer composed of PEPE on the surface, and suppresses an increase in the temperature of the second lubricating layer. As a result, it is possible to obtain a magnetic recording medium with excellent signal characteristics and heat resistance even during the recording and reproduction of signals with a magnetic head such as a GMR head when the temperature of the recording film rises under laser beam irradiation.

### Fourth Embodiment

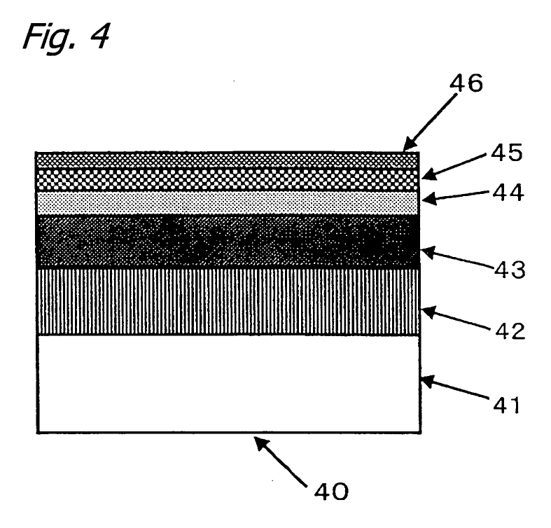

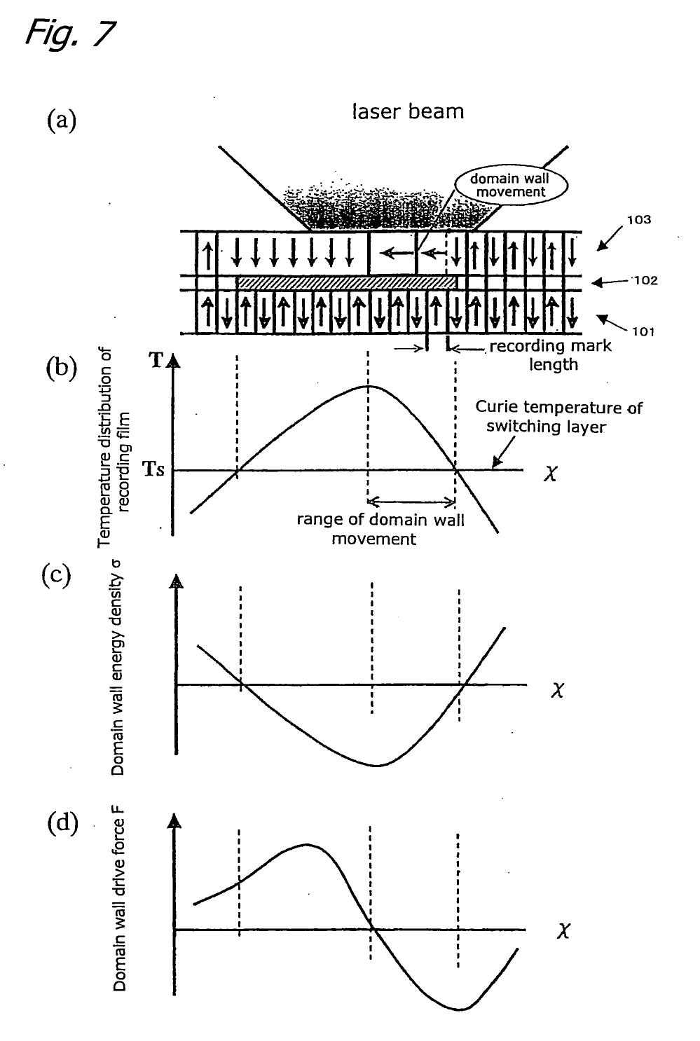

FIG. 4 is a cross-sectional view of the structure of a magnetic disk 40 in a fourth embodiment of the present invention. 41 is a disk substrate made of a metal (such as an aluminum substrate), and 42 is a dielectric layer for protecting the recording film and adjusting the base. 43 is a laminated recording film, and as shown in FIG. 7, is made up of a recording layer 101 in which recording information is stored, a reproduction layer 103 for detecting information by the displacement of a domain wall, and an intermediate layer (or an intermediate blocking layer) 102 for controlling exchange coupling between the reproduction layer and the recording layer. 44 is a protective layer for shielding the recording film 43 and the lubricating layer from heat, and a first lubricating layer 45 and a second lubricating layer 46 are further formed to improve the float characteristics of the magnetic head.

With the magnetic disk 40 shown in FIG. 4, the walls of recording domains transferred from the recording layer 101 through the intermediate layer 102 to the reproduction layer 103 are displaced one after the other by the temperature gradient produced by the laser beam. A DWDD system (Domain Wall Displacement Detection) can be applied, in which super-resolution reproduction is possible by using the magnetic layer to detect this displacement of the domain wall, and thereby raising the detection sensitivity of the magnetic head during reproduction.

A recording film laminated in the configuration discussed above is an example of DWDD in which the displacement of the domain wall is utilized to increase the amplitude of the reproduction signal and the signal capacity, in which a magnetic film having a large interfacial saturated coercive force is used as the recording layer, a magnetic layer having a small interfacial saturated coercive force is used as the reproduction layer that displaces the magnetic domain wall, and an intermediate layer is used for switching transfer between magnetic films having a relatively low Curie temperature. Therefore, the present invention is not limited to the above film configuration, as long as a magnetic film that allows the use of DWDD is used.

The principle of reproducing with a DWDD system will now be described through reference to FIG. 7.

FIG. 7a is a cross-sectional view of the recording film of a rotating magnetic disk. There is a disk substrate and a dielectric layer (not shown), over which are formed a three-layer recording film comprising a reproduction layer 103, an intermediate layer 102, and a recording layer 101, a dielectric layer (not shown; used as a heat-blocking layer), and over this, a lubricating layer.

A magnetic film material with a small domain wall coercive force is used as the reproduction layer 103, a magnetic film with a low Curie temperature is used as the intermediate layer 102, and a magnetic film capable of storing a recording magnetic domain even with a small domain diameter is used as the recording layer 101. Here, the reproduction layer forms a guard band or the like between recording tracks, resulting in a magnetic domain structure including an unclosed magnetic domain wall.

As shown in the drawing, information signals are formed as recording magnetic domains which are thermomagnetically recorded in the recording layer. The recording layer, the intermediate layer, and the reproduction layer are strongly exchange-coupled in the recording film at room temperature (not being irradiated with a laser beam spot), so the recording magnetic domains of the recording layer are transferred and formed as they are to the reproduction layer.

FIG. 7b is a graph of the temperature T of the recording film versus the position χ corresponding to the cross-sectional view in FIG. 7a. During the reproduction of a recorded signal, the disk rotates and a reproduction beam spot produced by the laser beam is emitted along the tracks. At this point, the recording film has the temperature distribution shown in FIG. 7b, there is a temperature region Ts where the intermediate layer is at or over the Curie temperature Tc, and exchange coupling is interrupted between the reproduction layer and the recording layer.

Also, when a reproduction beam is emitted, since the magnetic domain wall energy density σ has a gradient in the χ direction of the rotating disk direction corresponding to the positions in FIGS. 7a and 7b, a force F that drives the magnetic domain wall acts on the magnetic domain wall in each of the layers at the position χ, as shown in FIG. 7d.

The force F acting on the recording film displaces the magnetic domain wall in the direction of a lower magnetic domain wall energy σ. Since the domain wall coercive force is small and the domain wall has good mobility in the reproduction layer, with a reproduction layer alone having an unclosed magnetic domain wall, this force F readily displaces the magnetic domain wall. Therefore, as indicated by the arrows, the domain wall of the reproduction layer instantly moves to a region where the temperature is higher and the domain wall energy density is lower. When the domain wall passes through the reproduction beam spot, magnetization of the reproduction layer within the spot is aligned in the same direction over a wide area of the light spot.

As a result, the size of the reproduction domains is always at the maximum amplitude, regardless of the size of the recording domains. Accordingly, even when signals are reproduced using a magnetic head such as a GMR head, since the recording film is heated by the light beam or the like, the transferred magnetic domains in the reproduction layer are expanded, and a signal of the maximum amplitude is always obtained.

Next, the constitution of the magnetic disk 40, and how it is manufactured, will be described in detail.

As shown in FIG. 4, the recording film 43, which comprises multiple laminated layers including the above-mentioned magnetic films, is formed on the disk substrate 41. The disk substrate 41 is flat, and can be formatted after the formation of the recording film, by using a servo writer or the like to form a servo track or the like that will serve as a reference.

First, a silicon target is installed in a DC magnetron sputtering apparatus, and the disk substrate is fixed in a substrate holder, after which the inside of the chamber is vacuum evacuated with a turbo molecular pump to a high vacuum of 8×10⁻⁶ Pa or less. With this vacuum evacuation in progress, argon gas and N₂ gas are introduced into the chamber up to 0.3 Pa, and the substrate is rotated while a heat-blocking protective layer 34 composed of SiN is formed in a thickness of 20 nm by reacting sputtering over the disk substrate 41.

With the vacuum evacuation still in progress, argon gas is introduced into the chamber up to a pressure of 1.5 Pa, and the substrate is rotated while a recording layer is formed by DC magnetron sputtering in a thickness of 80 nm over the dielectric layer 42, using a TbFeCo alloy target. The TbFeCo film composition here can be matched to the desired film composition by adjusting the alloy target compositional ratio. Next, using a TbDyFeCoAl alloy target, an intermediate layer composed of TbDyFeCoAl is formed by DC magnetron sputtering in a thickness of 15 nm. Then, using a GdFeCoAl alloy target, a reproduction layer composed of GdFeCoAl is formed by DC magnetron sputtering in a thickness of 35 nm. This forms a recording film 43 with a three-layer structure comprising a recording layer, intermediate layer, and reproduction layer.

Then, argon gas and N₂ gas are introduced into the chamber until 0.3 Pa is reached, and the substrate is rotated while a protective layer 44 composed of SiN is formed in a thickness of 10 nm by reactive sputtering.

A first lubricating layer (solid lubricating layer) 45 composed of diamond-like carbon (DLC) is formed in a thickness of 12 nm over the protective layer 44 by reactive RF sputtering, using a carbon target in a mixed atmosphere of argon and CH₄. A second lubricating layer 46 composed of perfluoropolyether is then formed in a thickness of 2 nm by coating.

The composition of the recording film 43 composed of TbFeCo here was adjusted by setting the compositional ratio of the target so that the temperature of compensation composition would be 100° C. and the Curie temperature 310° C. The TbDyFeCoAl intermediate layer is adjusted to a temperature of compensation composition of 20° C. and a Curie temperature of 180° C., and the GdFeCoAl reproduction layer to a temperature of compensation composition of 160° C. and a Curie temperature of 290° C. As a result, the film characteristics thus obtained are such that the coercive force Hc rises from room up to the temperature of compensation composition, but decreases when the temperature is further raised. Also, the saturation magnetization Ms of the reproduction layer rises along with the temperature, reaching its maximum at 160° C., and when the intermediate layer is at or over the Curie temperature, exchange coupling between the recording layer and the reproduction layer is interrupted, so even tiny recording marks will be transferred to the reproduction layer and detected as a large signal capacity.

As a result, with the magnetic disk 40 of this embodiment, the saturation magnetization Ms is high over a range of from 150° C. to 190° C., which is the temperature range under irradiation with the laser beam. Accordingly, because of magnetically induced super resolution, stable recording magnetic domains can be formed, without surrounding recording magnetic domains being transferred even in the recording of tiny magnetic domains, and recording and reproduction with excellent signal characteristics are possible even when repeated recording and reproduction are performed with a magnetic head.

### Fifth Embodiment

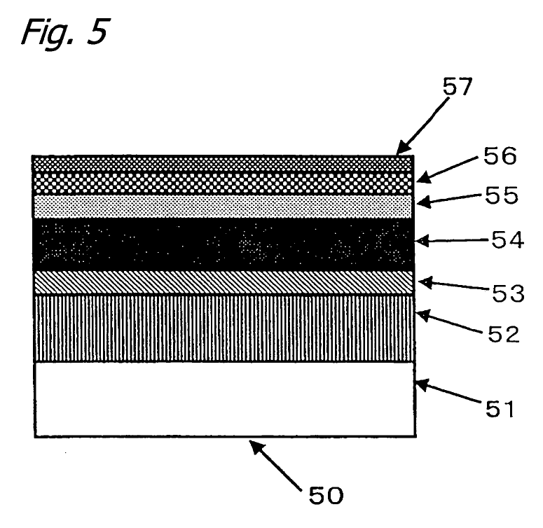

FIG. 5 is a cross-sectional view of the structure of a magnetic disk 50 in a fifth embodiment of the present invention.

51 is a disk substrate made of transparent glass, and 52 is a heat-radiating layer composed of a metal material with a high thermal conductivity, and which diffuses heat from the recording film and protects the recording film. A laminated recording film 54 is formed over the heat-radiating layer 52 with a heat-resistant layer 53 interposed therebetween. The laminated recording film 54 is formed by a recording layer in which recorded information is stored, a reproduction layer for increasing the signal capacity of reproduction information, and an intermediate layer for controlling the exchange coupling force between the reproduction layer and the recording layer. A heat-blocking protective layer 55 for shielding the recording film 54 and the lubricating layer is formed over the recording film 54. A first lubricating layer 56 and a second lubricating layer 57 are further formed to improve the float characteristics of the magnetic head.

Just as in the fourth embodiment, a DWDD system can be applied to the magnetic disk 50, in which the approaching magnetic domain walls are displaced one after the other by the temperature gradient produced by the laser beam, and this displacement of the domain walls is detected by the magnetic head, so that super-resolution reproduction is possible by increasing the detection sensitivity of the magnetic head during reproduction. The laser beam here is incident from the second lubricating layer 57 side. The recording and reproduction of signals are performed using a magnetic head, and the recording and reproduction of recording marks smaller than the diffraction limit of the irradiating laser beam spot are possible.

As a result, the size of the reproduction domains is always at the maximum amplitude, regardless of the size of the recording domains. Accordingly, even when signals are reproduced using a magnetic head such as a GMR head, since the recording film is heated by the light beam or the like, the transferred magnetic domains in the reproduction layer are expanded, and a signal of the maximum amplitude is always obtained.

The laminated recording film with the above configuration is an example of magnetic films with which it is possible to use DWDD, in which the displacement of the domain walls is utilized to increase the amplitude of the reproduction signal and the signal capacity, but the present invention is not limited to this film configuration.

Next, the constitution of the magnetic disk 50, and how it is manufactured, will be described in detail.

As shown in FIG. 5, the recording film 54, which comprises multiple laminated layers including the above-mentioned magnetic films, is formed on the glass disk substrate 51. The disk substrate 51 has a format in which rewritable regions are provided in a track alternately with pit regions in which servo-use wobble pits and address pits have been formed. An address is detected while a tracking servo is actuated, and information can be recorded to and reproduced from the rewritable regions. The constitution here is such that there are prepits having a depth of from 20 to 180 nm, signals from the prepits of address pits or the like can be detected, and recording and reproduction can be accomplished.

First, an AlTi target is installed in a DC magnetron sputtering apparatus, and the disk substrate is fixed in a substrate holder, after which the inside of the chamber is vacuum evacuated with a turbo molecular pump to a high vacuum of 8×10⁻⁶ Pa or less. With this vacuum evacuation in progress, argon gas is introduced into the chamber up to 0.5 Pa, and the substrate is rotated while a heat-radiating layer 52 composed of a metal material (AlTi) is formed in a thickness of 80 nm over the disk substrate 51.

With the vacuum evacuation still in progress, argon gas and N₂ gas are introduced into the chamber up to a pressure of 0.3 Pa, and the substrate is rotated while a heat-resistant layer 53 composed of AlTiN is formed by reactive sputtering in a thickness of 10 nm over the heat-radiating layer 52.

With the vacuum evacuation still in progress, argon gas is introduced into the chamber up to a pressure of 1.5 Pa, and the substrate is rotated while a recording layer is formed by DC magnetron sputtering in a thickness of 80 nm over the heat-resistant layer 53, using a TbFeCo alloy target. The chromium film composition of the TbFeCo here can be matched to the desired film composition by adjusting the alloy target compositional ratio. Next, using a TbDyFeCoCr alloy target, an intermediate layer composed of TbDyFeCoCr is formed by DC magnetron sputtering in a thickness of 15 nm. Then, using a GdFeCoCr alloy target, a reproduction layer composed of GdFeCoCr is formed by DC magnetron sputtering in a thickness of 35 nm. A recording film 54 with a three-layer structure comprising a recording layer, intermediate layer, and reproduction layer can be formed by the above method.

Then, argon gas and N₂ gas are introduced into the chamber until 0.3 Pa is reached, and the substrate is rotated while a protective layer 55 composed of SiN is formed in a thickness of 10 nm by reactive sputtering.

A first lubricating layer (solid lubricating layer) 56 composed of diamond-like carbon (DLC) is formed in a thickness of 8 nm over the protective layer 55 by reactive RF sputtering, using a carbon target in a mixed atmosphere of argon and CH₄. This product is coated with a second lubricating layer 57 composed of perfluoropolyether in a thickness of 2 nm.

The composition of the recording layer composed of TbFeCoCr here was adjusted by setting the compositional ratio of the target so that the temperature of compensation composition would be 20° C. and the Curie temperature 300° C. The TbDyFeCoCr intermediate layer is adjusted to a temperature of compensation composition of 50° C. and a Curie temperature of 180° C., and the GdFeCoCr reproduction layer to a temperature of compensation composition of 160° C. and a Curie temperature of 290° C. As a result, the temperature characteristics of the film thus obtained are such that the coercive force Hc is large at room temperature, but decreases when the temperature is raised. Also, the saturation magnetization Ms of the reproduction layer rises along with the temperature, reaching its maximum at 160° C., and when the intermediate layer is at or over the Curie temperature, exchange coupling between the recording layer and the reproduction layer is interrupted, so even tiny recording marks will be transferred to the reproduction layer by DWDD and detected as a large signal capacity.

As a result, with the magnetic disk 50 of this embodiment, the saturation magnetization Ms is high over a range of from 120° C. to 180° C., which is the temperature range under irradiation with the laser beam. Accordingly, because DWDD involving magnetically induced super resolution is used, stable recording magnetic domains can be formed, without surrounding recording magnetic domains being transferred even in the recording of tiny magnetic domains, and because the signal amplitude can be increased, recording and reproduction with excellent signal characteristics are possible even when repeated recording and reproduction are performed with a magnetic head.

### Sixth Embodiment

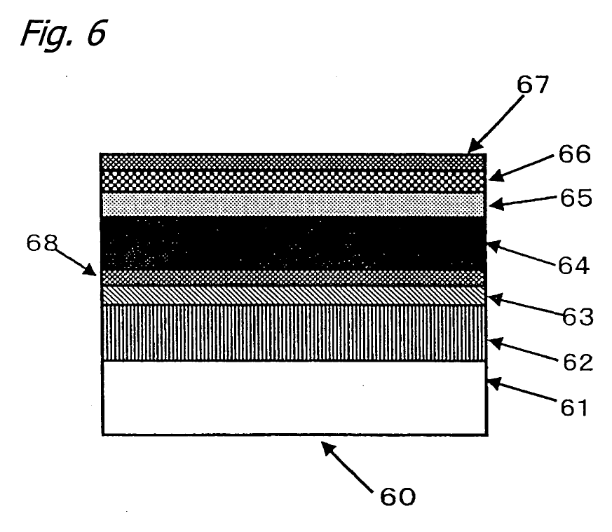

FIG. 6 is a cross-sectional view of the structure of a magnetic disk 60 in a sixth embodiment of the present invention.

61 is a transparent disk substrate made of a flat sheet of glass, and 62 is a heat-radiating layer composed of a metal material with a high thermal conductivity, and which diffuses heat from the recording film and protects the recording film. A laminated recording film 64 is formed over the heat-radiating layer 62 with a heat-resistant layer 63 interposed therebetween. The laminated recording film 64 is formed by a recording layer in which recorded information is stored, a reproduction layer for increasing the signal capacity of reproduction information, and an intermediate layer for controlling the exchange coupling force between the reproduction layer and the recording layer. A heat-blocking protective layer 65 for shielding the recording film 64 and the lubricating layer is formed over the recording film 64. A first lubricating layer 66 and a second lubricating layer 67 are further formed to improve the float characteristics of the magnetic head. The side of the substrate on which the recording film 64 is formed is prepared by adjusting the surface roughness of the underlying dielectric layer by ion etching.

Just as in the fifth embodiment, a DWDD system can be applied to the magnetic disk 60, in which the approaching magnetic domain walls are displaced one after the other by the temperature gradient produced by the laser beam, and this displacement of the domain walls is detected by the magnetic head, so that super-resolution reproduction is possible by increasing the detection sensitivity of the magnetic head during reproduction. The laser beam here is incident from the second lubricating layer 67 side. The recording and reproduction of signals are performed using a magnetic head, and the recording and reproduction of recording marks smaller than the diffraction limit of the irradiating laser beam spot are possible.

As a result, the size of the reproduction domains is always at the maximum amplitude, regardless of the size of the recording domains. Accordingly, even when signals are reproduced using a magnetic head such as a GMR head, since the recording film is heated by the light beam or the like, the transferred magnetic domains in the reproduction layer are expanded, and a signal of the maximum amplitude is always obtained. A similar effect is obtained with a configuration in which signals are reproduced using an optical head with a high NA.

The laminated recording film with the above configuration is an example of magnetic films with which it is possible to use DWDD, which is a method in which the displacement of the domain walls is utilized to increase the amplitude of the reproduction signal and the signal capacity, but the present invention is not limited to this film configuration.

Next, the constitution of the magnetic disk 60, and how it is manufactured, will be described in detail.

As shown in FIG. 6, the recording film 64, which comprises multiple laminated layers including the above-mentioned magnetic films, is formed on the glass disk substrate 61. The disk substrate 61 is flat, and can be formatted after the formation of the recording film, by using a servo writer or the like to form a servo track or the like that will serve as a reference. With this servo track, an address is detected with an optical head and a magnetic head at the same time while a tracking servo is actuated, which allows information to be recorded and reproduced.

First, an AlCr target is installed in a DC magnetron sputtering apparatus, and the disk substrate is fixed in a substrate holder, after which the inside of the chamber is vacuum evacuated with a turbo molecular pump to a high vacuum of 8×10⁻⁶ Pa or less. With this vacuum evacuation in progress, argon gas and a minute amount of N₂ gas are introduced into the chamber up to 0.3 Pa, and the substrate is rotated while a heat-radiating layer 52 composed of a metal material (AlCr) is formed in a thickness of 50 nm over the disk substrate 61.

With the vacuum evacuation still in progress, more argon gas and N₂ gas are introduced into the chamber up to a pressure of 0.4 Pa, and the substrate is rotated while a under heat-blocking layer 63 composed of AlCrN is formed by reactive sputtering in a thickness of 15 nm. An etched surface 68 with a surface roughness Ra greater than 0.3 nm was formed with an ion gun on the surface of the under heat-blocking layer 63.

With the vacuum evacuation still in progress, argon gas is introduced into the chamber up to a pressure of 1.5 Pa, and the substrate is rotated while a recording layer is formed by DC magnetron sputtering in a thickness of 100 nm over the etched surface 68 of the under heat-blocking layer 63, using a TbGdFeCo alloy target. The composition of the TbGdFeCo here can be matched to the desired film composition by adjusting the alloy target compositional ratio. Next, using a TbFeCoCr alloy target, an intermediate layer composed of TbFeCoCr is formed by DC magnetron sputtering in a thickness of 15 nm. Then, using a GdFeCoCr alloy target, a reproduction layer composed of GdFeCoCr is formed by DC magnetron sputtering in a thickness of 40 nm. A recording film 64 with a three-layer structure comprising a recording layer, intermediate layer, and reproduction layer can be formed by the above method.

Then, argon gas and N₂ gas are introduced into the chamber until 0.3 Pa is reached, and the substrate is rotated while a protective layer 65 composed of AlTiN is formed in a thickness of 5 nm by reactive sputtering.

A first lubricating layer (solid lubricating layer) 66 composed of diamond-like carbon (DLC) is formed in a thickness of 6 nm over the protective layer 65 by reactive RF sputtering, using a carbon target in a mixed atmosphere of argon and CH₄. This product is coated with a second lubricating layer 67 composed of perfluoropolyether in a thickness of 3 nm.

The composition of the recording layer composed of TbGdFeCo here was adjusted by setting the compositional ratio of the target so that the temperature of compensation composition would be 40° C. and the Curie temperature 320° C. The TbFeCoCr intermediate layer is adjusted to a temperature of compensation composition of 120° C. and a Curie temperature of 190° C., and the GdFeCoCr reproduction layer to a temperature of compensation composition of 20° C. and a Curie temperature of 300° C. As a result, the temperature characteristics of the film thus obtained are such that the coercive force Hc is large at room temperature, but decreases when the temperature is raised. Also, the saturation magnetization Ms of the reproduction layer rises along with the temperature, reaching its maximum at 220° C. Further, when the intermediate layer is at or over the Curie temperature, exchange coupling between the recording layer and the reproduction layer is interrupted, so even tiny recording marks will be transferred to the reproduction layer by DWDD and detected as a large signal capacity.

As a result, with the magnetic disk 60 of this embodiment, the saturation magnetization Ms is high over a range of from 120° C. to 220° C., which is the temperature range under irradiation with the laser beam. Accordingly, because DWDD involving magnetically induced super resolution is used, stable recording magnetic domains can be formed, without surrounding recording magnetic domains being transferred even in the recording of tiny magnetic domains, and recording and reproduction with excellent signal characteristics are possible even when repeated recording and reproduction are performed with a magnetic head.

As discussed above, even when a recording film with a three-layer structure comprising a recording layer, intermediate layer, and reproduction layer is used, the recorded information of the recording layer can be stably detected by the magnetic head, and even when recording and reproduction are performed at high density, stable signal characteristics are obtained.

As a result, with the present invention, because the structure is such that a lubricating layer is formed via a heat-blocking layer over a recording film having a structure in which a recording layer capable of rewriting recorded information, an intermediate layer, and a reproduction layer are laminated in that order, tiny magnetic domains of 0.3 μm or less can be stably formed, and the reproduction signals transferred to the reproduction layer can be larger. Furthermore, since the recording magnetic domains in the information track are formed in a stable shape, there is also less cross-write and cross-talk from adjacent tracks during recording and reproduction.

### Seventh Embodiment

The recording and reproduction method and recording and reproduction apparatus using a magnetic recording medium in an embodiment of the present invention will now be described in detail through reference to the drawings.

The method for recording and reproduction with a magnetic recording medium in this embodiment of the present invention involves irradiating the magnetic recording medium discussed above with a laser beam spot, thereby raising the temperature of the recording film while transferring the recording magnetic domains formed in the recording layer of the magnetic recording medium to the reproduction layer, and information is recorded and reproduced using an optical head or a magnetic head such as a GMR head. Alternatively, information is recorded and reproduced using an optical head that emits a laser beam during recording or during reproduction.

The above-mentioned recording and reproduction method is constituted such that a laser beam is used to record, reproduce, and erase information, for example. During recording and reproduction, the laser beam spot is made incident from the reproduction layer side while being moved relative to the magnetic recording medium, and the light reflected by the magnetic recording medium, or a magnetic signal, is used to control tracking while a temperature distribution is formed that has a gradient with respect to the direction of movement of the laser beam spot over the magnetic recording medium. Here, a temperature distribution having a high temperature range, in which the force produced in the domain walls that attempts to move the domain walls in the direction of a higher temperature is greater than the coupling force produced from the recording layer via the intermediate layer, is formed in the reproduction layer. As a result, magnetic domains in which information has been transferred from the recording layer in the interior of the light spot are formed in the reproduction layer, and information that has been formed larger by domain wall displacement in the reproduction layer is detected as a change in the polarization plane of the light reflected from the light spot.

Alternatively, the above-mentioned recording and reproduction method may be constituted, for example, such that the temperature of a magnetic recording medium is raised by a laser beam while a magnetic head is used to record or erase information, and a GMR head is used to reproduce information. During the recording of information, the laser beam spot is emitted while being moved relative to the magnetic recording medium, the magnetic head is disposed on the recording layer or the reproduction layer side of the magnetic recording medium, and the magnetic field direction is modulated according to the recorded information, thereby performing tracking control, while information is recorded to or erased from the recording layer of the magnetic recording medium. With this method for recording and reproduction to and from a magnetic recording medium, during the reproduction of information, the magnetic recording medium is irradiated with the laser beam spot to form a temperature distribution having a gradient with respect to the movement direction of the magnetic disk, a GMR head for information reproduction is disposed on the reproduction layer side, and information whose signal capacity has increased along with the Ms, or information formed larger by domain wall displacement that causes the transferred domains of recorded information transferred from the recording layer through the intermediate layer to move toward a higher temperature due to a temperature gradient in the reproduction layer, is detected by the GMR head.

If the film composition is different in the depth direction of the reproduction layer, it is possible to employ a magnetic recording medium reproduction method in which information is detected by expanding recorded magnetic domains that have been transferred in stages and thereby displacing the domain walls. Furthermore, it is possible to employ a method for the recording and reproduction of a magnetic recording medium in which the coupling force produced via the intermediate layer of the magnetic recording medium is either a magnetic coupling force, an exchange coupling force, or a magnetostatic coupling force, so that transfer is only performed from a temperature range that allows the transfer of a signal by magnetic coupling force between the recording layer an the reproduction layer, and the signal is detected by expanding the transferred magnetic domains.

FIG. 9 is an example of the magnetic recording medium recording and reproduction apparatus in an embodiment of the present invention. With a magnetic recording medium (hereinafter referred to as magnetic disk) 10 attached to a spindle motor 113, signals are recorded and reproduced by a magnetic head controlled by a detection circuit 116 and magnetic head control. Here, an optical head 114 for thermally assisting the magnetic recording medium irradiates the disk with a laser beam that is controlled by a laser drive circuit 115. A control circuit 117 controls the rotational drive of the motor, the servo control of the laser beam, and so forth.

The above recording and reproduction apparatus allows information signals to be recorded and reproduced while a tracking servo is actuated, by means of magnetically recorded pits, or pits with a concave or convex surface shape, in the magnetic disk of this embodiment.

The optical head here was described as being disposed in the opposite direction from the magnetic head, but the configuration may instead be such that irradiation is from the same side as the magnetic head, or such that the magnetic head and the optical head are integrated, or such that the magnetic head is integrated with a waveguide path connected to a light source.

Again with the above configurations, the recording and reproduction apparatus of the this embodiment allows information signals to be recorded and reproduced with a magnetic head while a magnetic recording medium is heated with an optical head.

### Eighth Embodiment

A recording layer will be used to describe an example of how the layers that make up the magnetic recording medium of the present invention are formed.

A recording layer can be produced by magnetron sputtering using an alloy target that is a mixture of the required materials, or by multi-element co-sputtering with targets made of the various metal materials, with the ultimate vacuum during film formation being 1.0×10⁻⁵ Pa or less, and the pressure of the gas introduced during film formation set to at least 0.6 Pa and no more than 6.0 Pa.

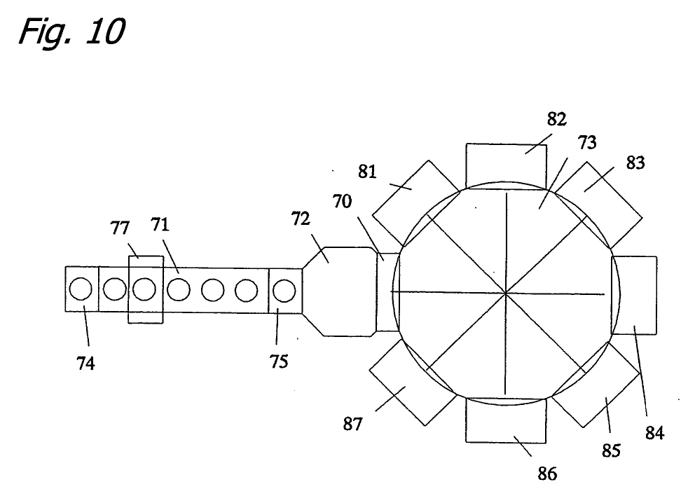

FIG. 10 shows an example of a film formation apparatus. 70 is a vacuum transport chamber, 71 is a vacuum degassing chamber, 72 is a loading and unloading chamber, 73 is a vacuum main chamber, 74 is a loading chamber, 75 is an unloading chamber, 77 is a heating chamber, and 81 to 87 are vacuum processing chambers.

The gas introduced here may include at least argon gas, neon gas, krypton gas, and xenon gas. The effect will be better if the partial pressures of O₂, H₂O, N₂, and H₂ with respect to the pressure during the above-mentioned film formation are no higher than 100 ppm. These partial pressures with respect to the sputtering gas can be easily measured by connecting a gas analysis system to the vacuum chamber.

The recording layer of the magnetic recording medium in the above embodiment was formed at a deposition rate of from 0.7 to 5 nm/sec during film formation, but as long as it is at least 0.5 nm/sec and no more than 10 nm/sec, even if the composition of the recording film that is formed should vary as a result of the bias magnetic field, the gas pressure of argon, neon, krypton, xenon, or the like, the periodic lamination method, or other such film formation conditions during film formation in the manufacturing process, it will still be possible for an inert gas to be contained in the film, and the desired recording layer can be formed.

Furthermore, the signals of the recording layer can be increased, or transferred to the reproduction layer and the domain walls smoothly displaced, so that reproduction can be performed with expanded magnetic domains, by controlling the film formation apparatus conditions, such as a multi-element co-sputtering method, or a stationary opposing type of sputtering method.

### Other Embodiments

Examples of the configuration of the magnetic recording medium of the present invention, examples of the recording and reproduction method, and so forth were discussed above. Other working examples of the various layers, and the method for recording and reproduction with magnetic recording media in which these layers are used will now be described.

Disk Substrate

The disk substrates in the embodiments given above were described as having a configuration in which guide grooves or prepits were formed, as was a fine pattern using a photopolymer, in a polycarbonate, metal, or glass substrate. There are no particular restrictions on the material of the disk substrate, however, as long as it satisfies the mechanical properties and other such characteristics required of a medium substrate, and can be glass, polycarbonate, polyolefin, epoxy resin, another plastic material, or the like. A fine pattern may be formed directly on these. Furthermore, the disk substrate may be a metal substrate, or a combination of a glass substrate and a plastic material. When glass is used, the substrate can be manufactured by 2P method using a UV-setting resin. The fine pattern formed from a photopolymer on the glass substrate was described above as a circular pattern of 0.3 μm, but may be a pattern of 0.5 μm or less, or may consist of bumps smaller than the smallest recorded magnetic domains, or bumps that are hemispherical, square, or some other shape, and as long as the fine shape is uniform and does not lead to signal noise from the recorded magnetic domains, there will be the same effect of stabilizing the tiny magnetic domains of the recording layer.

The configuration of the disk substrate was described above as being flat and equipped with prepits or spiral or ring-shaped guide grooves for tracking guidance of the light spot. Here, the track pitch of the disk substrate is from 0.4 to 0.8 μm, and the groove width is from 0.3 to 0.6 μm. However, the disk substrate may also be configured such that the disk substrate is provided with wobbling spiral guide grooves having address information, or with undulating prepits for tracking guidance (such as a sample servo system). Here, the if the groove between recorded information tracks is interrupted by rectangular or inverse V-shaped lands, or if the recording track is interrupted by a groove, the configuration may be such that the track pitch is 1.0 μm or less, and there is a groove or land with a width of from 0.1 to 0.8 μm between lands or grooves where information is recorded. A magnetic recording medium of even higher density can be obtained by further shortening the track pitch.

Also, a configuration in which the surface roughness Ra of the information recording surface was increased to at least 1.0 nm by etching of the under layer in the various embodiments, but a magnetic recording medium having a similar effect can be obtained if the surface roughness Ra of the recording surface is adjusted to at least 0.5 nm by increasing the particle size of the base material during film formation.

Protective Layer

The dielectric protective layer was described above as having configurations involving the use of an SiN film and an AlTiN film, but a ZnS film, a ZnS—SiO₂ film, or another chalcogen compound dielectric film, an oxide film such as TaO₂, a nitride film such as AlCrN, or a thin film of these compounds may be used instead. The dielectric layer will have its protective effect as long as its film thickness is between 2 and 300 nm. A Teflon thin film was discussed as a heat-resistant protective layer, but this may be any thin film material with excellent heat resistance, such as PTFE (polytetrafluoroethylene (4 fluoride)), PPA (tetrafluoroethylene-perfluoroalkyl vinyl ether copolymer), FEP (tetrafluoroethylene-hexafluoropropylene copolymer (4-6 fluoride), ETFE (tetrafluoroethylene-ethylene copolymer), and other such Teflons (fluororesins or tetrafluoroethylene resins), or a ceramic material composed of an oxide (SiO₂, Al₂O₃, BaO, CaO, B₂O₃ZnO, B₂O₃, La₂O₃, PbO), a nitride (Si₃N₄, AlN, BN, etc.), a carbide (SiC, TiC, B₄C, WC, etc.), a boride (LaB₆, TiB₂, ZrB₂, etc.), a sulfide (CdS, MOS₂, etc.), a silicide (MOSi₂), or a compound (element) containing no oxygen as a nonmetal element, such as carbon. This layer may also be composed of a metal material such as titanium, tantalum, or chromium, or one of these metal materials to which additives or a nitrogen compound has been added.

In addition to a configuration in which the recording layer is provided either directly over the substrate or with a protective layer interposed therebetween, a configuration in which a heat-sink layer or the like is provided may also be used. The material of the heat-sink layer in this case may be an alloy material containing one or more of AlTi, titanium, aluminum, copper, silver, and gold, with this material having a higher thermal conductivity than the recording film. The protective layer may have a thickness of at least 0.5 nm and no more than 99.5 nm.

Lubricating Layer

The lubricating layer was described as being composed of a DLC layer or a PFPE material, but an instead contain a urethane resin or an alumina-based lubricating material, or a slidable coating material may be combined with a UV-setting resin, thermosetting resin, or the like, or a hot melt adhesive, or the like. The lubricating layer may have a thickness of at least 0.5 nm and no more than 20 nm, and the combined thickness of the lubricating layer and the protective layer may be at least 1 nm and no more than 100 nm.

Dielectric Layer

The dielectric layer formed over the recording layer is a hard, transparent layer, and is preferably composed of a hard material such as diamond-like carbon (DLC) or AlN, SiN, GeN, Ta₂O₅, TiO₂, or HfO₂. When a dielectric layer with a low thermal conductivity, such as ZnS—SiO₂, is used, it is preferable to laminate a hard material such as diamond-like carbon (DLC) or AlN, SiN, GeN, Ta₂O₅, TiO₂, or HfO₂ over the dielectric layer. The thickness of the protective layer is set so as to increase the signal output from recorded marks.

A protective coating may be provided on the substrate side of the magnetic recording medium of the present invention, and is preferably made up of an inorganic or organic material with a thickness of at least 1 μm and no more than 200 μm. With an organic material, a relatively hard resin such as an acrylic UV-setting resin can be applied by spin coating. With an organic material, a coating of silica, alumina, or the like can be applied by sol-gel method. A transparent sheet may also be applied with an adhesive agent. If the thickness of the protective coating is at least 20 nm and no more than 20 μm, a good film thickness distribution can be easily obtained by spin coating, and even if the protective coating is this thin, problems such as decrease corrosion resistance can be minimized by performing tape burnishing or other such processing.

In order to prevent scratching caused by instantaneous contact between the head and the medium, which is a concern with a system in which an objective lens is placed on a floating slider head, and a floating magnetic head is provided between the objective lens and the medium, the protective layer may be coated with a lubricant such as perfluoroether or silicone oil.

Reflective Layer

A material with high reflectivity at the wavelength of the laser being used, such as gold, silver, copper, or aluminum, is used for the reflective layer. To ensure the hardness of the overall thin films and ensure durability, the reflective layer may be alloys of the above metals with other metals. If the recording layer is thick enough, no reflective layer is necessary. The dielectric layer that is intermediate between the recording layer and the reflective layer may be composed of SiN, GeN, Ta₂O₅, ZnS—SiO₂, or the like.

Recording Film

The various layers comprising the recording film were described as the reproduction layer being composed of GdFeCoAl or GdFeCoCr, the intermediate layer TbDyFeCo, TbDyFeCr, or TbFeCoCr, and the recording layer TbFeCo, TbFeCoCr, or TbGdFeCo, but TbFe, TbHoFe, TbCo, GdCo, GdTbFe, GdTbFeCo, GdTbHoFeCo, DyFeCo, GdFeCoSi, or another such rare earth-transition metal-based ferrimagnetic amorphous alloy, or a material that is a mixture of these, or a magnetic material in which a polycrystalline material of a manganese-based magnetic film such as MnBi, MnBiAl, or PtMnSn is used, or garnet, PtCo, PdCo, or another such platinum series-transition metal alloy, or Pt/Co, Pd/Co, or another such gold or platinum series-transition metal periodic structure alloy film, or the like may be used instead. A recording film made up of a plurality of recording layers of different materials or compositions, including the above-mentioned materials, may be used, or a mixture of these. Also, when the above magnetic layers are doped with chromium, aluminum, titanium, platinum, niobium, or the like to improve corrosion resistance, the effect will be equal to or better than that of this embodiment if the Ms·Hc value is set higher than that specified. The recording film may be intermittently and periodically laminated in layers of different materials or compositions.

The film structure of the laminated recording film was described above as comprising a reproduction layer with a thickness of 30 to 40 nm, an intermediate layer with a thickness of 5 to 15 nm, and a recording layer with a thickness of 60 to 100 nm, but is not to limited to the film thicknesses given above. As long as adequate magnetic coupling force is obtained between the recording layer and the reproduction layer so as to satisfy the characteristics of the present invention, the film thickness may range from 5 to 200 nm. Preferably, for example, if the reproduction layer is from 10 to 100 nm, the intermediate layer from 5 to 50 nm, and the recording layer from 30 to 250 nm, the same effect will be obtained. A control layer with a thickness of 5 to 50 nm may also be added.

The configuration may also include an auxiliary recording layer, transfer control layer, or other magnetic films in order to improve recording and reproduction characteristics. Furthermore, a magnetic film with a multilayer structure in which the domain wall energy density or the composition is varied in the film thickness direction may be provided as an intermediate layer.

The recording layer in this embodiment had a configuration in which terbium and FeCo were periodically laminated at 1.5 nm, but is not limited to this configuration. If the lamination period is at least 0.4 nm and no more than 2 nm and the thickness of the recording layer is at least 50 nm, and preferably from 60 to 200 nm, the same effect will be obtained. Corrosion-resistant elements such as chromium, titanium, zirconium, niobium, and tantalum may be added to increase the corrosion resistance of the recording layer, or neodymium or the like may be added in an amount of a few atom percent to raise the Kerr rotational angle at short wavelengths.

Also, when a phase-change recording material is used, the recording layer is made up of a material whose optical constant varies between crystalline and amorphous, such as GeSbTe or AgInSbTe. The thickness of the recording layer is preferably at least 10 nm and no more than 40 nm.

If thin films are formed all the way to the outer peripheral edge on both sides, conduction between the two sides will be achieved at the outer peripheral edge, and if the medium is grounded on one side or the other this will eliminate static electricity. In a preferred configuration, the stress is balanced between the thin films on both sides. The error rate is reduced here because the amount of tilt can be sufficiently reduced.

The recording layer in this embodiment was described as having an Ms-Hc value of 4.2×10⁶ erg/cm³, but is not limited to this value. If the recording film yields a higher Ms·Hc value, then even when tiny magnetic domains of 100 nm or smaller are recorded, stable recording domains can still be formed, and recording and reproduction with excellent signal characteristics will be possible even in repeated recording and reproduction.

The thermal conductivity of the recording film is about from 3×10⁶ erg/(s·K·cm) to 7×10⁶ erg/(s·K·cm), and since the thermal conductivity of the material of the heat-radiating layer (aluminum, an aluminum alloy, silver, a silver alloy, gold, or the like) is from 1×10⁷ erg/(s·K·cm) to 4×10⁷ erg/(s·K·cm), a protective layer whose thermal conductivity is 1×10⁶ erg/(s·K·cm) or less may be used. Here, as long as the protective layer has a thermal conductivity of 1×10⁶ erg/(s·K·cm), then a magnetic recording medium with excellent heat resistance, sliding characteristics, and heat blocking characteristics between the recording layer and the lubricating layer can be obtained even with a configuration that makes use of a material such as SiO₂, TiO₂, MgO, SiN, or TiN whose thermal conductivity is from 0.13×10⁶ erg/(s·K·cm) to 1×10⁶ erg/(s·K·cm), or ZnS (2.5×10⁵ erg/(s·K·cm)), or the like.

Recording and Reproduction Method

An example of how recording and reproduction are performed using the magnetic disk of this embodiment will now be given.

This magnetic disk has rectangular lands and grooves. Recording and reproduction by the above-mentioned DWDD method will be possible as long as the tracks where information is recorded are magnetically shielded from each other by annealing between recorded tracks or forming lands with deep grooves, and the recorded magnetic domains transferred to the reproduction layer readily undergo domain wall displacement.

Also, this magnetic disk has a configuration in which grooves or lands including the reproduction layer are separated from each other, or a configuration in which a flat disk substrate is used, but the same characteristics will be obtained with a configuration in which information is recorded to both the lands and the grooves, or a configuration in which the recorded magnetic domains are separated by a fine pattern.

Furthermore, in this embodiment the track pitch was 0.7 μm, but the effect will be better with a configuration in which the grooves in which information is recorded are no wider than 0.6 μm, and the information is recorded to domains in which the shortest mark length of the recorded information is 0.3 or less.

As discussed above, with the constitution of this embodiment, stable reproduction signal characteristics will be obtained even when high-density recording and reproduction are performed by DWDD.

Further, a magnetic recording medium featuring DWDD or a recording film with which the Ms value increases at higher temperatures, and a recording and reproduction method involving the use of this medium, were discussed above, but it is also possible to use another domain wall displacement type of magnetic domain expanded reproduction method, a reproduction magnetic domain expanded reproduction method involving a shrinkage operation, a reproduction magnetic field alternating type reproduction method, or the like. That is, if the configuration is such that a recording and reproduction method is used for obtaining higher recording density and enhancing signal quality, and information is recorded to and reproduced from a recording film without a disk substrate being interposed, the recording of tiny magnetic domains will have excellent stability, and high-density recording and reproduction will be possible at a high sensitivity that allows signals to be reproduced easily.

As discussed above, with the present invention, a recording film that allows the rewriting of recorded information is used, and tiny magnetic domains of 0.3 μm or smaller are formed stably, so good mobility of the domain walls can be ensured, and reproduction signals can be expanded by displacement of transferred magnetic domains by DWDD or another such method. Furthermore, since the recorded magnetic domains in the information track are formed in a stable shape, there is also less cross-write and cross-talk from adjacent tracks during recording and reproduction.

### INDUSTRIAL APPLICABILITY

With the magnetic recording medium and its manufacturing method pertaining to the present invention, a lubricating layer is formed over a recording film formed on a disk substrate, with a protective layer having a lower thermal conductivity than the recording film interposed between the lubricating layer and the recording film, which is useful in rewritable magnetic recording media, and particularly in magnetic recording media that record and reproduce signals while the temperature of the recording medium is raised by irradiation with light, and other such media. Also, this constitution can be applied as a method for recording and reproduction to and from a magnetic recording medium, for example.

1-45. (canceled)

46. A magnetic recording medium having at least a magnetically anisotropic recording film on a disk substrate,
comprising a lubricating layer over at least the recording film, with a protective layer having a lower thermal conductivity than the recording film being interposed therebetween.

47. The magnetic recording medium according to claim 46, wherein the protective layer has a thermal conductivity of 1×10⁶ erg/(s·K·cm) or less.

48. The magnetic recording medium according to claim 46, wherein the protective layer comprises a plurality of thin films.

49. The magnetic recording medium according to claim 48, wherein the plurality of thin films each have a different thermal conductivity.

50. The magnetic recording medium according to claim 49, wherein the protective layer comprising a plurality of thin films is formed such that the thermal conductivity of the thin film on the recording film side is higher than the thermal conductivity of the thin film on the lubricating layer side.

51. The magnetic recording medium according to claim 49, wherein the protective layer comprising a plurality of thin films has at least a thin film whose thermal conductivity is 1×10⁶ erg/(s·K·cm) or less.

52. The magnetic recording medium according to claim 46, wherein the main component of the protective layer is carbon.

53. The magnetic recording medium according to claim 52, wherein the protective layer includes diamond-like carbon.

54. The magnetic recording medium according to claim 53, wherein the protective layer includes nitrogen, oxygen, or hydrogen.

55. The magnetic recording medium according to claim 54, wherein the nitrogen, oxygen, or hydrogen content is varied within the plurality of thin films of the protective layer.

56. The magnetic recording medium according to claim 46, wherein the protective layer includes a material having heat resistance at a temperature of at least 250° C.

57. The magnetic recording medium according to claim 56, wherein the heat resistant material is composed of a fluororesin or a ceramic material.

58. The magnetic recording medium according to claim 56, wherein the heat resistant material is composed of Teflon®.

59. The magnetic recording medium according to claim 46, wherein the protective layer includes a metal material.

60. The magnetic recording medium according to claim 59, wherein the metal material is composed of titanium, tantalum, and chromium.

61. The magnetic recording medium according to claim 59, wherein the metal material is composed of a nitrogen compound or an oxide.

62. The magnetic recording medium according to claim 46, wherein the protective layer includes at least a chalcogen compound.

63. The magnetic recording medium according to claim 46, wherein the lubricating layer comprises a plurality of thin films.

64. The magnetic recording medium according to claim 63, wherein the plurality of thin films each have a different thermal conductivity.

65. The magnetic recording medium according to claim 63, wherein the lubricating layer includes PFPE.

66. The magnetic recording medium according to claim 63, wherein the lubricating layer includes a heat resistant material.

67. The magnetic recording medium according to claim 63, wherein the lubricating layer includes an oxide or a nitride.

68. The magnetic recording medium according to claim 46, wherein the combined thickness of the lubricating layer and the protective layer is at least 1 nm and no more than 100 nm.

69. The magnetic recording medium according to claim 68, wherein the thickness of the lubricating layer is at least 0.5 nm and no more than 20 nm.

70. The magnetic recording medium according to claim 68, wherein the thickness of the protective layer is at least 0.5 nm and no more than 99.5 nm.

71. The magnetic recording medium according to claim 46, wherein the recording film includes a magnetic layer having magnetic anisotropy in the direction perpendicular to the film plane.

72. The magnetic recording medium according to claim 46, wherein the recording film comprises a plurality of magnetic layers.

73. The magnetic recording medium according to claim 72, wherein the recording film comprises at least a recording layer, an intermediate layer, and a reproduction layer, which are laminated over one another.

74. The magnetic recording medium according to claim 73, wherein the recording domain formed on the recording layer in the recording film is transferred to the reproduction layer, and recorded information is reproduced by domain wall displacement in the reproduction layer.

75. The magnetic recording medium according to claim 73, wherein the recording layer includes at least terbium, iron, and cobalt.

76. The magnetic recording medium according to claim 73, wherein the recording layer is laminated intermittently and periodically for each layer of different material or compositional ratio.

77. The magnetic recording medium according to claim 46, wherein a pit-shaped pattern is formed on the disk substrate according to the pattern of the recording domain formed in the recording layer.

78. The magnetic recording medium according to claim 77, wherein a pit-shaped pattern that is smaller than the smallest pattern of the recording domain formed in the recording layer is formed on the disk substrate.

79. The magnetic recording medium according to claim 77, wherein at least a metal layer with a high thermal conductivity is provided between the disk substrate and the recording film.

80. The magnetic recording medium according to claim 79, wherein a dielectric layer is provided between the recording film and the metal layer.

81. The magnetic recording medium according to claim 79, wherein a dielectric layer is provided between the disk substrate and the metal layer.

82. The magnetic recording medium according to claim 79, wherein at least the metal layer or the dielectric layer has an etched surface.

83. The magnetic recording medium according to claim 82, wherein at least the metal layer or the dielectric layer has a surface roughness Ra of at least 0.5 nm.

84. The magnetic recording medium according to claim 80, wherein the dielectric layer includes at least a chalcogen compound.

85. A method for manufacturing a magnetic recording medium having at least a magnetically anisotropic recording film on a disk substrate, comprising:
forming at least a magnetically anisotropic recording film on a disk substrate;
forming a protective layer having a lower thermal conductivity than the recording film over the recording film; and
forming a lubricating layer over the protective layer.

86. The method for manufacturing a magnetic recording medium comprising according to claim 85, wherein the lubricating layer is formed in a vacuum.

87. The method for manufacturing a magnetic recording medium comprising according to claim 86, wherein the lubricating layer is formed by coating after the protective layer has been formed.

88. An apparatus for manufacturing a magnetic recording medium having at least a magnetically anisotropic recording film on a disk substrate, the apparatus comprising:
a recording film formation unit for forming at least a magnetically anisotropic recording film on a disk substrate;
a protective layer formation unit for forming a protective layer having a lower thermal conductivity than the recording film over the recording film; and
a lubricating layer formation unit for forming a lubricating layer over the protective layer.

89. A method for recording to or reproducing from a magnetic recording medium having at least a magnetically anisotropic recording film on a disk substrate,
wherein information is recorded to or reproduced from the magnetic recording medium by applying a laser beam to the magnetic recording medium according to claim 46 to raise the temperature of the recording film of the recording medium.

90. An apparatus for recording to or reproducing from a magnetic recording medium having at least a magnetically anisotropic recording film on a disk substrate, comprising:
a heating unit for raising the temperature of the magnetic recording medium according to claim 46; and
a recording and reproduction unit for magnetically recording and reproducing signals to and from the magnetic recording medium when the heating unit raises the temperature of the magnetic recording medium,
wherein the temperature distribution in the signal region of the magnetic recording medium during signal recording to the magnetic recording medium is different from that during signal reproduction.
